(19) United States
(12) Patent Application Publication
(10) Pub. No.: US 2020/0251957 A1
(43) Pub. Date: Aug. 6, 2020

(54) COIL VIBRATION SYSTEM

(71) Applicant: PRIMETALS TECHNOLOGIES USA LLC, Alpharetta, GA (US)

(72) Inventor: Steven Spencer, Windham, ME (US)

(73) Assignee: PRIMETALS TECHNOLOGIES USA LLC, Alpharetta, GA (US)

(21) Appl. No.: 15/776,219

(22) PCT Filed: Dec. 5, 2016
(86) PCT No.: PCT/US2016/064918

§ 371 Date: May 15, 2018

Related U.S. Application Data
(60) Provisional application No. 62/263,928, filed on Dec. 7, 2015.

(51) Int. Cl. H02K 7/06; B21C 47/24

(52) U.S. Cl. CPC H02K 7/063; B21C 47/24

(57) ABSTRACT

A system is disclosed for vibrating a coil carried on a pallet, with the pallet being supported on and movable along a conveyor. The system includes an elevator mechanism for lifting and supporting the pallet in a raised position spaced above the conveyor. Vibration motors serve to vibrate the elevator mechanism, thereby also serving to vibrate the raised pallet and the coil carried thereon.

This application claims priority to U.S. provisional application Ser. No. 62/263,928 filed on Dec. 7, 2015, the contents of which are incorporated herein by reference.

### FIELD OF THE INVENTION

This invention relates generally to hot rolling mills producing rods, bars and other like long products which are directed to pouring reels or reform stations where they are gathered as superimposed rings in upstanding coils, and is concerned in particular with a system for vibrating such coils to more uniformly re-order their rings and thereby decrease their height.

### DESCRIPTION OF THE PRIOR ART

Long product mills typically accumulate rod and smaller bar products into coils that are compacted and bound for storage, shipping, and finally pay-off to the end user's machinery. The coils must comprise well-ordered packages to survive such processes without damage from material handling equipment.

The coils must be bound tight and held secure while compacted by relatively high compacting forces. The compacting forces are known to damage the product rings when there is a loose overlay pattern in the ring array resulting in the compacting forces being applied to a minimized cross sectional area of the coil wall. This is evident when the un-compacted coil heights are relatively high, signaling a disarrayed ring pattern within the coil. Well-ordered rings provide more surface areas to withstand compacting pressures and thereby diminish any potential galling damage due to rings slipping violently over adjacent rings during compaction. This type of damage is not normally seen from the outside of the coil and not detected until the coil arrives at the customer's payoff equipment. At this point the coils have a high rate of rejection, particularly when the product is a low carbon, stainless steel alloy or other relatively soft steel.

To deal with these problems, coil packages are sometimes subjected to a water and soap high pressure spray (or similar liquid) to provide some lubricant to the rings. The idea is that the lubricant will allow the loose overlaid rings to slip more freely during the compaction process without surface galling. Depending upon the coil temperature, this process may change the product properties; accelerate rusting of the product and cause rapid corrosion of the material handling equipment due to the ambient steam environment.

### SUMMARY OF THE INVENTION

In accordance with one aspect of the present invention, after the coils leave the pouring reels or reform station, they are subjected to vibration, which re-orders and more uniformly distributes the rings, thus decreasing coil height and any potential internal ring damage during subsequent compaction and banding. The vibration system is fully automatic and requires no liquids or lubricants. Thus, there is no risk of changing the product's metallurgical properties, or the product rusting, staining or being contaminated by foreign materials.

In accordance with another aspect of the present invention, the coils are enclosed and radially contained during vibration, thereby preventing any tendency of the coils to fall to one side.

In an exemplary embodiment of a system in accordance with the present invention, a coil is carried on a pallet, with the pallet being supported on and movable along a conveyor. An elevator mechanism serves to lift and support the pallet in a raised position spaced above the conveyor. A vibration inducing means is employed to vibrate the elevator mechanism and to thereby also vibrate the pallet and the coil carried thereon.

The elevator mechanism may comprise a lift frame vertically adjustable between a lower position spaced beneath the pallet supported on the conveyor, and an upper position supporting the pallet in its raised position above the conveyor.

Clamps may be provided for releasably securing the pallet to the lift frame when the lift frame is in its raised position. The lift frame may be vertically adjustable by wedge assemblies. Vibration isolation mounts may be interposed between the lift frame and the wedge assemblies.

The means for vibrating the elevator mechanism may comprise vibration motors configured and arranged to vibrate the lift frame.

The coil may be internally supported by a stem projecting vertically from the pellet, and means in the form of pivotal side guides may be provided for radially confining the coil when the pallet is in its raised position.

### BRIEF DESCRIPTION OF THE DRAWINGS

FIG. 1 is a front view of a coil vibration station in accordance with an exemplary embodiment of the present invention, showing the pallet at rest on the conveyor prior to the coil undergoing vibration;

FIG. 2 is a view similar to FIG. 1 showing the pallet lifted from the conveyor in readiness for a vibration cycle;

FIG. 3 is a view similar to FIGS. 1 and 2 showing the addition of vertical guides in their open positions;

FIG. 4 is a view similar to FIG. 3 showing the guides in their closed positions; and

FIG. 5 is a perspective view of a vibration isolation mount.

### DETAILED DESCRIPTION

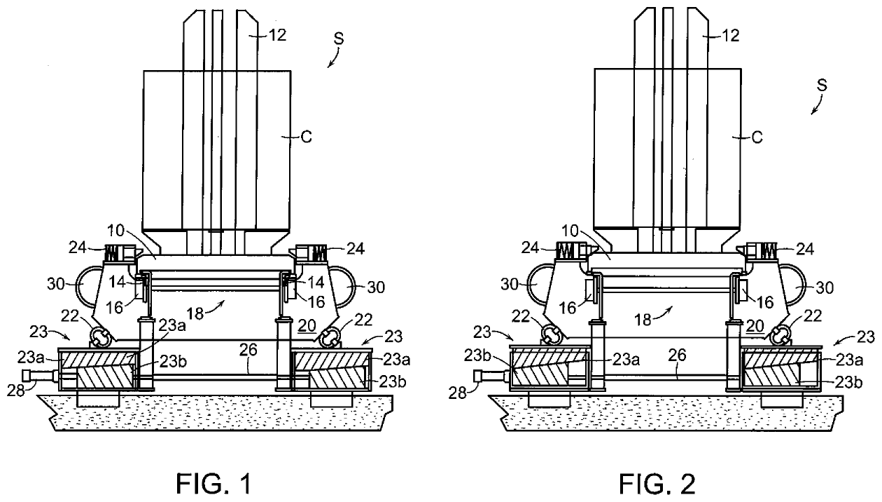

With reference initially to FIG. 1, a coil “C” is shown supported on a pallet 10. The pallet has a stem 12 projecting vertically through the center of the coil. The pallet is in turn supported as at 14 on the rollers 16 of a conveyor generally indicated at 18. In a typical installation, conveyor 18 will extend from the mill's pouring reels or reform station (not shown) to coil compactors (also not shown).

A vibration station “S” at a location along the conveyor includes a lift frame 20 supported by vibration isolation mounts 22, which may be of the type depicted in FIG. 5. The vibration isolation mounts serve to support the lift frame on wedge assemblies 23.

Spring applied hydraulically releasable clamps 24 are provided on the lift frame 20 on opposite sides of the pallet 10. At the stage shown in FIG. 1, the clamps 24 are hydraulically released to accommodate freedom of movement of the pallet 10 along the conveyor 18.

The wedge assemblies 23 may comprise upper and lower wedge components 23a, 23b, with the lower wedge components being joined by a connecting rod 26 and operated by a hydraulic cylinder 28.

Vibration motors 30, which may for example be electric external vibrators of the type supplied by Netter GmbH, are mounted on either side of the lift frame 20.

As depicted in FIG. 1, the coil C has been received from a pouring reel or reform station and carried on the pallet 10 to the vibration station S.

As shown in FIG. 2, the lower wedge components 23b of the wedge assemblies 23 are activated by the hydraulic cylinder 28 (pulled to the left) to lift the frame 20, resulting in the pallet 10 being raised off of the conveyor rollers 16.

The clamps 24 are closed to firmly anchor the pallet 10 on the frame 20, after which the vibration motors 30 are activated to vibrate the frame 20 along with the pallet 10 and the coil C carried thereon. Coil vibration serves to more uniformly re-order the rings without external force, thereby decreasing coil height and avoiding potential internal ring damage.

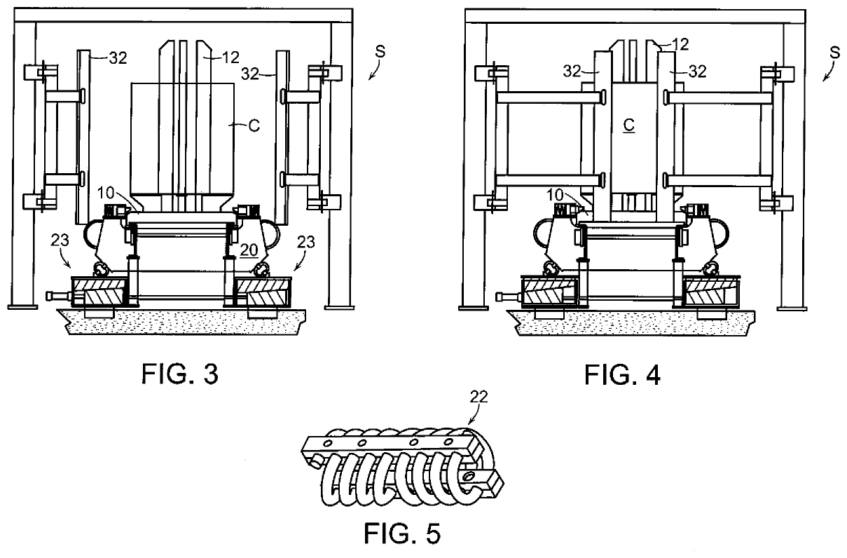

Advantageously, the vibration station S may be equipped with means in the form of pivotal side guides 32, shown in open positions in FIG. 3 on opposite sides of the conveyor 18. When the pallet is in its raised position, as shown in FIG. 4, the side guides may be closed to enclose and radially confine the coil as it is being vibrated.

What is claimed is:

1. A system for vibrating a coil carried on a pallet, with the pallet being movable along a conveyor, said system comprising:
an elevator mechanism for lifting and supporting the pallet at a raised position spaced above said conveyor; and
means for vibrating said elevator mechanism to thereby vibrate the pallet and the coil carried thereon.

2. The system of claim 1, wherein said elevator mechanism comprises a lift frame vertically adjustable between a lower position spaced beneath the pallet supported on said conveyor, and an upper position supporting the pallet in said raised positions.

3. The system of claim 2, further comprising clamps for releasably securing said pallet to said lift frame when said lift frame is in said raised position.

4. The system of claim 2, wherein said lift frame is vertically adjustable by wedge assemblies.

5. The system of claim 4, further comprising vibration isolation mounts interposed between said lift frame and said wedge assemblies.

6. The system of claim 2, wherein said means for vibrating comprises vibration motors configured and arranged to vibrate said lift frame.

7. The system of claim 1, wherein said coil is internally supported by a stem projecting vertically from said pallet.

8. A system for vibrating a coil carried on a pallet, with the pallet being movable along a conveyor, said system comprising:
a lift frame vertically adjustable between a lower position spaced beneath the pallet supported on said conveyor, and an upper position supporting the pallet in a raised position spaced above said conveyor; and
vibrating motors configured and arranged to vibrate said lift frame in said upper position.
